(19) United States
(12) Patent Application Publication
(10) Pub. No.: US 2010/0092609 A1
(43) Pub. Date: Apr. 15, 2010

(54) METHOD FOR PRODUCING CHEESE

(76) Inventors: Albertus Alard van Dijk, Vlaardingen (NL); Natalja Alekseevna Cyplenkova, Vlaardingen (NL); Johanna Bernardina Remmerswaal, Delft (NL); Lambertus Jacobus Otto Guillonard, Den Haag (NL); Baukje Folkertsma, Delft (NL)

Correspondence Address: NIXON & VANDERHYE, PC, 901 NORTH GLEBE ROAD, 11TH FLOOR, ARLINGTON, VA, 22203, US

(21) Appl. No.: 12/520,644

(22) PCT Filed: Dec. 18, 2007
(86) PCT No.: PCT/EP2007/064115

§ 371 Date: Nov. 12, 2009

(30) Foreign Application Priority Data
Dec. 21, 2006 (EP) 06126886.8

(51) Int. Cl. A23C 19/032; A23C 19/04

(52) U.S. Cl. 426/37; 426/62

(57) ABSTRACT

A method of producing curd or cheese from a milk composition comprising the following steps:—heat-treating the milk composition;—adding yeast extract to the heat-treated milk composition before or after the heat treatment;—coagulating the heat treated milk to form a gel;—processing the formed gel into a curd and separating the whey from the curd; and—optionally making cheese from the curd.

### FIELD OF THE INVENTION

The invention relates to a method of producing cheese.

### BACKGROUND OF THE INVENTION

Coagulation is an essential step in the traditional production of cheese from a dairy composition such as bovine milk.

The coagulation may be started by acidification and/or the addition of an enzyme (coagulant) such as chymosine. After coagulation, the milk is separated into curd and whey. The curd is processed further into cheese. Caseins form the main protein component of the curd, and since cheese is a more valuable product than whey there is a desire to maximize the amount of protein incorporated into the curd. The inclusion of whey proteins into the curd would lead to an increase in cheese yield (=kg cheese produced from 1 L cheese milk), which is desirable.

Cheese manufacturing processes from various milk sources have long been known and have been described in detail for many different types of cheese variants. (see e.g. Cheese: Chemistry, Physics and Microbiology, Vol 1&2, 1999, Ed. Fox, Aspen Publications, Gaithersburg, Md.; Encyclopedia of Dairy Sciences Vol 1-4, 2003, Academic Press, London). A crucial point in cheese manufacture is the process of coagulation, in which the solubility of the casein micelles and submicelles is decreased. Enzyme induced coagulation is very commonly used. Enzymes like calf chymosine, microbial equivalents of chymosine and other enzymes from other sources have been described and several are available under various trade names. All of them can be used to initiate the coagulation process. The primary step in coagulation is the cleavage of the Phe₁₀₅-Met₁₀₆ bond in κ-casein. This leads to removal of the C-terminal part of κ-casein: the glycomacropeptide (GMP). Removal of the GMP leads to association of the casein micelles, i.e casein coagulation. Casein coagulation leads to gel formation, and the time required to obtain gelling in a particular dairy composition is directly related to the activity of the coagulant.

The time that passes between addition of the coagulant and appearance of initial casein flocculation is defined as the coagulation time. The speed at which the gel is formed in cheese milk and the compactness of the gel depend closely on the quantity of enzyme added, the concentration of calcium ions, phosphorous, temperature and the pH. After the initial coagulation, a gel is formed and the consistency of the gel increases following an increase in the inter-micellar bonds. The micelles move together and the coagulum contracts, hereby expelling the whey. This phenomenon is known as syneresis and is accelerated by cutting the curd, increasing the temperature and increasing the acidity produced by the developing lactic acid bacteria.

For microbiological safety, cheese milk is heat treated prior to use. Various heat-treatments are used for milk such as thermisation (65° C., few seconds), low pasteurization (72° C., 15 seconds), high pasteurization (85° C., 20 seconds) and ultra high Temperature (UHT) treatment (e.g. 1 second, 145° C.). The heat treatment increases the keeping quality of milk and destroys micro-organisms. Furthermore, for certain dairy applications a particular heat treatment may be required to obtain the desired characteristics of the end product, such as in yogurt-making. Heat treatment may lead to impaired milk properties for cheese making purposes (see e.g. Singh & Waungana, Int Dairy J (2001), 11, 543-551). Heat treatments that lead to impaired milk clotting properties such as increased coagulation time, decreased curd firming rate or decreased curd strength will in the remainder of this text be referred to as ‘high heat treatment’; the resulting milk will be referred to as ‘high heated milk’ throughout this text.

Significant changes occurring upon heating milk above 60° C. include denaturation of whey proteins, interactions between denatured whey proteins and the casein micelles and the conversion of soluble calcium, magnesium and phosphate to the colloidal state. Casein micelles are very stable at high temperatures although changes in zeta-potential, size of hydration of micelles, as well as some association-dissociation reactions do occur at severe heating temperatures (Singh & Waungana, Int Dairy J (2001) 11, 543-551; and references cited therein). Upon heating milk above 65° C., whey proteins are denatured by the unfolding of their peptides. The unfolded proteins then interact with casein micelles or simply aggregate themselves, involving thiol-disulfide interchange reactions, hydrophobic interactions and ionic linkages. Ionic strength, pH and concentration of calcium and protein influence the extent of denaturation of the whey proteins. Heat denaturation of proteins is also influenced by lactose and other sugars, polyhydric alcohols and protein modifying agents.

Denatured whey proteins have been shown to associate with κ-casein on the surface of the casein micelles. The principle interaction is considered to be between β-lactoglobulin and κ-casein and involves both disulfide and hydrophobic interactions (Singh and Fox, J Dairy Res (1987) 54, 509-521). Part of the denatured whey proteins does not complex with the casein micelles, but form aggregates with other whey proteins. The extent of association of denatured whey proteins with casein micelles is markedly dependent on the pH of the milk prior to heating, levels of calcium and phosphate, milk solids concentration and type of heating system (water bath, indirect or direct). Indirect heating is reported to result in greater proportions of β-lactoglobulin and α-lactalbumin associating with the micelles compared to the situation where direct heating is used (e.g. steam injection). Heating at pH values less than 6.7 results in a greater quantity of denatured whey proteins associating with the micelles, whereas a higher pH values whey protein/κ-casein complexes dissociate from the micelle surface (Singh & Waunanga, Int Dairy J (2001) 11, 543-551).

Heat-treatment results in various changes in the milk. The most obvious change is the partial or full denaturation of whey proteins. The degree of denaturation depends on the heat treatment and the conditions in the milk such as pH and presence of additives like carbohydrates. Heat treatment of milk results in the formation of whey protein aggregates containing both α-lactalbumin and β-lactoglobulin (Singh & Waungana, Int Dairy J (2001), 11, 543-551; Vasbinder, Casein-whey protein interactions in heated milk, Thesis, ISBN 90-393-3194-4). The casein micelle fraction is not noticeably affected in the temperature range 70-100° C. Calcium phosphate, which is also present in the casein micelles, precipitates upon heat treatment and only slowly redissolves after cooling. Heat treatment of milk also results in the interaction of denatured whey proteins with the casein micelles. The interaction may be covalent via disulfide bond formation between e.g. β-lactoglubulin and κ-casein, and these interactions stabilize the casein micelle. The final composition of heat-treated milk depends on the milk pH and the temperature applied. The properties of the heated milk are determined by the final milk composition.

High heated milk shows impaired clotting behavior (Singh & Waungana (2001), Int Dairy J. 11, 543-551). Clotting times are increased and a weaker, finer curd is formed that retains more water than normal. In literature there is controversy about the cause of the increase in clotting time. A generally accepted explanation is that the κ-casein GMP moiety has reacted with β-lactoglobulin, and that this causes steric hindrance for the coagulating enzyme leading to inhibition of the κ-casein cleavage (see e.g. Singh et al (1988) J Dairy Res. 55, 205). The phenomenon of a weaker curd is explained in several ways. One explanation for the weaker curd is that the κ-casein is insufficiently cleaved (see: Walstra & Jennes, (1984) Dairy Chemistry and Physics, John Wiley and sons Inc, USA). Another explanation is that the heat-induced calcium phosphate precipitation is responsible (see e.g. Schreiber (2001) Int. Dairy J. 11, 553). A third explanation is that whey-proteins denature during heat treatment and associate with the casein micelles, thereby interfering with casein micelle-micelle interactions (Vasbinder, Casein-whey protein interactions in heated milk, Thesis, ISBN 90-393-3194-4). It is unclear which of these explanations is the most relevant one.

It is known that the adverse effects of heat treatment on rennet coagulation can be overcome to some extent by either a) decreasing the pH to about 6.2, b) acidifying milk to below 5.5 followed by neutralization to 6.6 or c) adding calcium chloride (Lucey et al (1993) Cheese yield and factors affecting its control, special issue 9402 pp 448-456, International Dairy Federation). However, these remedies are not satisfactory solutions since the original curd strength and clotting time were not restored. Furthermore, extra handling of the cheese milk in case of pH adjustments is required. Recently, the use of protein hydrolysates was described as an alternative remedy to cure the poor clotting and curd forming properties of high heated milk (EP24557). This application describes a process in which high heated milk is used to prepare cheese; the protein hydrolysate is added after the heat treatment when the milk is cooled to cheese making temperatures, but prior to the addition of coagulant. It is demonstrated that the addition of the protein hydrolysate results in improved milk clotting and curd forming properties of the high heated milk. The possibility of using high heated milk for cheese making would be desirable. On the one hand the heat treatment increases the shelf life of the milk, allowing longer transport and storage times. On the other hand it leads to a significant increase in cheese yield. Increases up to 10% or more have been reported. However, factors preventing use of high heated milk are the increased clotting time and increased curd weakness (finer curd that retains more water than normal). Correlated to the curd weakness are increased cheese curd losses during curing and pressing of the cheese. There is an industrial need and desire to solve the drawbacks of high heated milk in cheese production. In addition there is a general need to reduce cost of raw materials in cheese making.

### SUMMARY OF THE INVENTION

It has surprisingly been found that the addition of a yeast extract to milk after the milk has received a high heat treatment in a cheese making process results in reduction or elimination of the increase in milk clotting time. Moreover, the addition of a yeast extract reduces or eliminates the increased curd weakness that would normally occur in such cases. Furthermore, the yeast extract reduces the amount of required starter culture. The yeast extract may be fortified by the addition of carboxylic acids such as malic acid, succinic acid, tartaric acid, adipic acid, citric acid or acetic acid, preferably malic acid.

The present invention relates to a method of producing curd or cheese from a milk composition comprising the following steps:
heat-treating the milk composition;
adding yeast extract to the heat-treated milk composition before or after the heat treatment;
coagulating the heat treated milk to form a gel;
processing the formed gel into a curd and separating the whey from the curd; and
optionally making cheese from the curd.

Preferably the coagulation is an enzymatic coagulation.

In an preferred embodiment the yeast extract is added after the heat treatment.

The invention relates to a method of producing cheese, comprising treating the milk composition at an elevated temperature for a sufficient period of time, preferably to cause impaired milk clotting behavior during the coagulation step, cooling the milk to cheese making temperatures, adding to the milk a yeast extract, of 0.01-0.2% (w/v), preferably 0.05-0.1% (w/v) followed by addition of suitable starter culture and a coagulant to form a gel and processing the formed gel into a cheese curd and separating the whey from the curd. According to the present process a curd is obtained which comprises a yeast extract. The invention also describes the use of a yeast extract to reduce the clotting time in a cheese making process whereby heat treated milk is used, and the use of a yeast extract to increase the curd strength of a curd in a cheese making process whereby heat treated milk is used.

According to the invention the yeast extract can be added to the milk before or after the milk is heat treated. Benefits of the yeast extract addition are for example the elimination of the increase in milk clotting time and reduction or elimination of the increased curd weakness that would normally occur and finally also the amount of required starter culture for the cheese making can be reduced. Preferably the yeast extract is added after the heat treatment.

In this text the terms ‘dairy composition’ and ‘milk’ will both be used; milk is considered as an example of a dairy composition herein.

Another aspect of the invention relates to a method of producing cheese, comprising 1) treating the cheese milk by high heat treatment, 2) adding to the cheese milk a yeast extract and 3) producing cheese from said dairy composition.

A further aspect of the invention relates to the cheese produced by the methods of the invention.

### DETAILED DESCRIPTION OF THE INVENTION

In the present context, the term ‘cheese’ refers to any kind of cheese such as e.g. natural cheese, cheese analogues and processed cheese. The cheese may be obtained by any suitable process known in the art such as e.g. by enzymatic coagulation of a dairy composition with rennet, or by acidic coagulation of a dairy composition with a food grade acid or acid produced by lactic acid bacteria growth. In one embodiment, the cheese manufactured by the process of the invention is rennet-curd cheese. The dairy composition may be subjected to a conventional cheese-making process.

Processed cheese is preferably manufactured from natural cheese or cheese analogues by cooking and emulsifying the cheese, such as with emulsifying salts (e.g. phosphates and citrate). The process may further include the addition of spices/condiments.

The term ‘cheese analogues’ refers to cheese-like products which contain fat (such as e.g. milk fat (e.g. cream) as part of the composition, and which further contain, as part of the composition, a non-milk constituent, such as e.g. vegetable oil.

The cheese produced by the process of the present invention comprises all varieties of cheese, such as soft cheese, semi-hard cheese and hard cheese. In cheese manufacture, the coagulation of a dairy composition is preferably performed either by rennet or by acidification alone resulting in rennet-curd and acid-curd cheese, respectively. Fresh acid-curd cheeses refer to those varieties of cheese produced by the coagulation of milk, cream or whey via acidification or a combination of acid and heat, and which are ready for consumption once the manufacturing without ripening is completed. Fresh acid-curd cheeses generally differ from rennet-curd cheese varieties (e.g. Camembert, Cheddar, Emmenthal) where coagulation normally is induced by the action of rennet at pH values 6.4-6.6, in that coagulation normally occurs close to the iso-electric point of casein, i.e. e.g. at pH4.6 or at higher values when elevated temperatures are used, e.g. in Ricotta at pH typically about 6.0 and temperature typically about 80° C. In a preferred embodiment of the invention, the cheese belongs to the class of rennet curd cheeses.

Mozzarella is a member of the so-called pasta filata, or stretched curd, cheese which are normally distinguished by a unique plasticizing and kneading treatment of the fresh curd in hot water, which imparts the finished cheese its characteristic fibrous structure and melting and stretching properties. In one embodiment the invention further comprises a heat-stretching treatment as for pasta filata cheeses, such as for the manufacturing of Mozzarella.

The current application distinguishes itself from the EP24557 in this respect that instead of a protein hydrolysate a yeast extract is used. This yeast extract can be used to cure the poor clotting and gelling properties of high heated milk, just as described in EP24557. However, in addition the yeast extract leads to a significant acceleration of growth of the starter culture which was not observed upon addition of similar amounts of protein hyrolysates as described in EP24557. This allows for a significant reduction of use of starter cultures in the case yeast extracts are used. The reduction in started cultures is up to a factor of 5, while maintaining the original cheese making process and the yield increase described in EP24557. The use of yeast extract results in a double cost benefit. Firstly, yeast extracts are much cheaper compared to e.g. whey protein hydrolysates. Secondly, the use of yeast extract reduces the amount of required starter culture in the cheese making process, reducing ingredient costs for the cheese maker.

### Relevance of the Rate of Acidification

In the initial phase of cheese making, acidification takes place. This is usually achieved through in situ production of lactic acid through fermentation of lactose by lactic acid bacteria (LAB). Direct acidification using acid (e.g. lactic acid or citric acid) is an alternative to biological acidification and is used commercially to a significant extent in the manufacture of cottage, quark, Mozzarella and feta-type cheese. Direct acidification is more controllable than biological acidification. The rate of acidification depends on the amount and type of starter added and on the temperature profile of the curd (Encyclopedia of dairy sciences, 2003, p 256-257. Ed: Roginski et al, Academic Press). The ultimate pH of most rennet-coagulated cheeses os 5.0-5.3, but the pH of acid-coagulated varieties, e.g. cottage, quark, cream and some soft rennet-coagulated varieties e.g. Camembert and Brie is at ˜4.6. The production of acid at the appropriate rate and time affects several aspects of cheese manufacture and is critical for the production of good quality cheese (Encyclopedia of dairy sciences, 2003, p 256-257. Ed: Roginski et al, Academic Press). Aspects that are affected by the acidification rate are:
coagulant activity during coagulation
denaturation and retention of coagulant in the curd
gel strength, which influences cheese yield
gel syneresis, which controls the moisture content of cheese and hence regulates the growth of bacteria and the activity of enzymes in the cheese;
colloidal calcium phosphate dissolves as the pH decreases
acidification controls the growth of many non-starter bacteria in cheese

The Encyclopedia of dairy sciences, (2003, p 256 and further, Ed: Roginski et al, Academic Press) describes in detail relevance of various aspects of cheese making.

“Dairy composition” or “milk composition” or “cheese milk”, which terms are used interchangeably, may be any composition comprising cows milk constituents but which comprises at least casein and whey. Milk constituents may be any constituent of milk such as milk fat, milk protein, casein, whey protein and lactose. A milk fraction may be any fraction of milk such as e.g. skim milk, butter milk, whey, cream, milk powder, whole milk powder, skim milk powder. In a preferred embodiment of the invention the dairy composition comprises milk, skim milk, butter milk, whole milk, whey, cream, or any combination thereof. In a more preferred embodiment the dairy composition consists of milk, such as skim milk, whole milk, cream or any combination thereof.

In further embodiments of the invention, the dairy composition is prepared, totally or in part, from dried milk fractions, such as e.g. whole milk powder, skim milk powder, casein, caseinate, total milk protein or buttermilk powder, or any combination thereof.

According to the invention the dairy composition comprises cow's milk and or one or more cow's milk fractions. The cow's milk fractions may be from any breed of cow (Bos Taurus (Bos taurus taurus), Bos indicus (Bos indicus taurus) and crossbreeds of these. In one embodiment the dairy composition comprises cow's milk and/or cow's milk fractions originating from two or more breeds of cows. The dairy composition also comprises milk from other mammals that are used for cheese preparation, such as milk derived from goat, buffalo or camel.

The dairy composition for production of cheese may be standardized to the desired composition by removal of all or a portion of any of the raw milk components and/or by adding thereto additional amounts of such components. This may be done e.g. by separation of milk into cream and milk upon arrival to the dairy. Thus, the dairy composition may be prepared as done conventionally by fractionating milk and recombining the fractions so as to obtain the desired final composition of the dairy composition. The separation may be made in continuous centrifuges leading to a skim milk fraction with very low fat content (i.e. <0.5%) and cream with e.g. >35% fat. The dairy composition may be prepared by mixing cream and skim milk. In another embodiment the protein and/or casein content may be standardized by the use of ultra filtration. The dairy composition may have any total fat content that is found suitable for the cheese to be produced by the process of the invention.

In one embodiment of the invention, calcium is added to the dairy composition. Calcium may be added to the dairy composition at any appropriate step before and/or during cheese making, such as before, simultaneously with, or after addition of starter culture. In a preferred embodiment calcium is added both before and after the heat treatment. Calcium may be added in any suitable form. In a preferred embodiment calcium is added as calcium salt, e.g. as CaCl₂. Any suitable amount of calcium may be added to the dairy composition. The concentration of the added calcium will usually be in the range 0.1-5.0 mM, such as between 1 and 3 mM. If CaCl₂ is added to the dairy composition the amount will usually be in the range 1-50 g per 100 liter of dairy composition, such as in the range 5-30 g per 1000 liter dairy composition, preferably in the range 10-20 g per 100 liter dairy composition.

The bacterial count of skim milk may be lowered by conventional steps. In an embodiment of the invention, the dairy composition may be subjected to a homogenization process before production of cheese, such as in the production of Danish Blue Cheese.

A “dairy product” is a product that comprises curd or cheese or comprises processed curd or cheese.

### Heat Treatment

It is well known that heat treatment of milk during commercial processing operations results in a number of physicochemical changes in the milk constituents. The type of changes and extent of these changes are determined by temperature of the treatment, the time of the heat treatment and the composition of the milk such as its pH, concentration of protein and fat and presence of cat ions like e.g. calcium and magnesium. Sometimes, a different combination of parameters can lead to the same or similar end result. For example, a short heat treatment at high temperature may have similar effects as a longer heat treatment at low temperature. It is known to the expert in the field how experimental parameters should to be changed to obtain similar end results for different processing routes, or how such routes should be established.

According to the invention the dairy composition is heat treated at an elevated temperature for a time that is preferably sufficient to cause impaired milk coagulation in the coagulation step. By impaired milk coagulation in cheese making is meant that the coagulation time is increased compared to the coagulation time in cheese making using non-heated milk. In addition the resulting curd is weaker compared to the curd prepared from milk with a regular heating process like pasteurization. The heat treatment may be performed at a temperature of at least 75° C., preferably at least 80° C. In one embodiment the heat treatment is conducted at a temperature between 75° C. and 145° C., in a preferred embodiment the heat treatment is conducted at a temperature between 75° C. and 120° C., in a more preferred embodiment the heat treatment is conducted at a temperature between 75° C. and 100° C., in an even more preferred embodiment the heat treatment is performed between 80° C. and 90° C. The duration of the heat treatment may be any time suitable to achieve impaired milk clotting behaviour. In one embodiment the duration of the heat treatment is between 1 second and 30 minutes. In one embodiment the heat treatment is conducted at 75° C. to 90° C. degrees for 5 seconds to 30 minutes, in another embodiment the heat treatment is conducted at 80° C. to 90° C. for 2 seconds to 30 minutes, in a still further embodiment the heat treatment is conducted at 80° C. to 145° C. from 1 second to 20 minutes. The heat treatment may be conducted by any method known in the art, such as e.g. in a plate heat exchanger, by batch wise heating of the milk in a tank or container or by steam injection. Heat treatment of whey proteins, either separately, in mixture or in milk, is a well known phenomenon and has been described in literature (e.g. Mulvihill & Donovan (1987) Ir. J. Food Sci. Techn. 11, 43-75). The quantitation of whey protein denaturation can be measured by determining the loss of solubility in the isoelectric pH range or on saturation with NaCl. Another manifestation of whey protein denaturation is the increased side group reactivity, especially the sulphydryl-groups of β-lactoglobulin (Mulvihill & Donovan (1987) Ir. J. Food Sci. Techn. 11, 43-75 and references sited therein). Milk pasteurization before cheese making results in very limited whey protein denaturation, less than 20% and preferably less than 10% of denaturation. When heat treatment is more severe, the degree of denaturation will increase, as described in literature (e.g. Law & Leaver (1997) J Agric Food Chem 45, 4255-4261; Law & Leaver (2000) J Agric Food Chem 48, 672-679). In contrast to pasteurization, the heat treatment of the present invention, high heat treatment of milk, will result in a much higher degree of whey denaturation of at least 30%, or for at least 40%, or for at least 50%, or for at least 60% or for at least 70% or even for at least 80%.

The effect of heat treatment is very sensitive to the time of heating and the exact temperature. Slight variations in heating time result in variation of the properties of the heated milk. In an industrial environment, heating processes are very well controlled and standardized. Laboratory processes are more difficult to control, and small variations of e.g. the heating time may result in slight alterations of the properties of the heated milk. This results in differences of 10-20% between individual heated milk batches, depending on the property that is measured.

“Yeast extracts” can be divided into two main groups, based on their method of preparation: autolytic yeast extracts and hydrolytic yeast extracts. “Autolytic yeast extracts” are concentrates of the soluble materials obtained from yeast after disruption of the cells and digestion (lysis) of the polymeric yeast material. The active yeast enzymes released in the medium after cell disruption are responsible for the lysis. Generally these types of yeast extracts do not comprise 5′-ribonucleotides because during the autolytic process the native RNA is decomposed or modified in a form which is not or almost not degradable into 5′-ribonucleotides. These types of yeast extract, which are rich in amino acids, are used in the food industry as basic taste providers. The amino acids present in the yeast extract add a bouillon-like, brothy taste to the food. “Hydrolytic yeast extracts”, on the other hand, are concentrates of the soluble materials obtained from yeast after disruption of the cells, digestion (lysis) and addition of proteases and/or peptidases and especially nucleases to the yeast suspension during lysis. The native yeast enzymes are inactivated prior to the lysis. During this process, 5′-ribonucleotides of guanine (5′-guanine mono phosphate; 5′-GMP), uracil (5′-uracil mono phosphate; 5′-UMP), cytosine (5′-cytosine mono phosphate; 5′-CMP) and adenine (5′-adenine mono phosphate; 5′-AMP) are formed. When adenylic deaminase is added to the mixture, 5′-AMP is transformed into 5′-inosine mono phosphate (5′-IMP). The hydrolytic yeast extracts obtained by this method are therefore rich in 5′-ribonucleotides, especially rich in 5′-GMP and 5′-IMP. Often yeast extracts are also rich in mono sodium glutamate (MSG).5′-IMP, 5′-GMP and MSG are known for their flavour enhancing properties. They are capable of enhancing the savoury and delicious taste in certain types of food. This phenomenon is described as ‘mouthfeel’ or umami. Yeast extracts rich in 5′-ribonucleotides and, optionally, rich in MSG, are usually added to soups, sauces, marinades and flavour seasonings.

For the purpose of this invention, yeast extracts may be fortified with carboxylic acids, such as malic acid, succinic acid, tartaric acid, adipic acid, citric acid or acetic acid, preferably malic acid. Addition of these carboxylic acid may be done before or after drying of the yeast extract, preferably before drying the yeast extract. The carboxylic acids may also be added to re-dissolved yeast extracts, after which the yeast extract may optionally be dried again using methods known in the art such as spray drying and freeze drying. The carboxylic acid may be added as the free acid or in the form of a salt of the acid, such as the ammonium salt. The addition of the carboxylic acid enhances the beneficial effects of the yeast extract in curing the poor renneting properties of high heated milk. The carboxylic acids may be added to the yeast extract at 1-10% (w/w) of dry matter, preferably 5-10% (w/w), more preferably 7-9% (w/w).

### Formaqraph

The “Formagraph” is an instrument designed to record coagulation properties of cheese milk. Its use as a tool to compare rennet solutions has been described (MacMahon & Brown, J Dairy Sci (1982) 65, 1639-1642). The Formagraph measurements allow the determination of three parameters during cheese making as detailed by McMahon & Brown. These are r: milk coagulation time, the time required to start gel formation, k₂₀: curd-firming time, the time between start of gel formation until a width of 20 mm is reached and a₃₀: curd firmness, the width of the graph 30 min after enzyme addition. The k₂₀ equates with a curd firmness, adequate for cutting of cheese curd. The Formagraph model 11700 (Foss Electric, Benelux) was used in the examples described below, using 87% glycerol as damper liquid. The r and k₂₀ times are expressed in mm, as measured on the recorder paper. A distance of 1 mm corresponds with a time period of 30 seconds.

### LEGEND TO THE FIGURES

FIG. 1 gives the acidification curves as a function of time for reduced amounts of starter cultures.

### Examples

### Example 1

### Effect of Yeast Extracts on the Coagulation of High Heated Milk

Low heat skim milk was prepared by by dissolving 11 grams of milk powder (Nilac, NIZO food research) in 100 grams of distilled water while gently stirring. This milk was heated for 10 minutes at 80° C., and cooled to 31° C. Non-heated milk was used as a reference. Milk samples were transferred to a Formagraph. Yeast extract was added (10% on protein base: 10 gram whey protein hydrolysate per 100 g milk protein) and milk coagulation was started by the addition of coagulant (0.08 IMCU per ml, Maxiren from DSM). Clotting time r and curd strength (k20) were determined. Results for several hydrolysates are given in table 1.

TABLE 1
Effect of various yeast extracts on milk clotting of high heated milk. All yeast
extracts were obtained from DSM, The Netherlands)

| | Yeast extract | | Type of yeast | r | k₂₀ |
|---|---|---|---|---|---|
| Sample | added | Batch code | extract | (in seconds) | (in seconds) |
| Non-heated | none | — | — | 300 | 780 |
| milk | | | | | |
| High heated | none | — | — | 480 | 3300 |
| milk | | | | | |
| High heated | Maxapure | FSGHE 50 | Hydrolytic | 360 | 1860 |
| milk | | | | | |
| High heated | Maxarome | DPGUC 11 | Hydrolytic | 360 | 1740 |
| milk | select | | | | |
| High heated | Maxarome | DWSAA 10 | Hydrolytic | 360 | 1680 |
| milk | premium | | | | |
| High heated | Maxarome | ERVHA 41 | Hydrolytic | 330 | 1710 |
| milk | plus | | | | |
| High heated | Gistex LS | AHGWA | Autolysate | 300 | 1410 |
| milk | | 02 | | | |
| High heated | Gistex std | FHSCA 07 | Autolysate | 330 | 1560 |
| milk | | | | | |

The data clearly demonstrate that the high heat treatment results in strongly increased r (from 300 to 480 seconds) and k₂₀ values (from 780 to 3300 seconds). All yeast extracts are able to improve the clotting properties of the high heated milk, but Gstex LS is most effective since it restores the r-value of the high heated milk to that of the non-heated milk and is the most effective in reducing the k₂₀ value of the high heated milk. All yeast extracts contain free glutamate which does not contribute to the improvement of milk clotting properties of the high heated milk as demonstrated in EP 24557 (example 5). Also nucleotides that are present in these yeast extract are not responsible for the improvement observed since the extracts that contain nucleotides (Maxapure and Maxarome products) are slightly inferior in performance compared to Gistex LS and Gistex std. Peptides, which are present in all extracts but most prominently in the autolysates, are most likely the components leading to improved milk clotting properties of the high heated milk.

### Example 2

### Preparation of Mozzarella at 1 Liter Scale

Mozzarella cheese was made on 1L scale as follows. 1 liter of pasteurized full fat cows milk was heated to 34° C. In some cases, mixtures of pasteurized and high heated milk were used, in which the volume percentage of high heated milk varied from 10%, 20%, 30%, 40%, 50% up to 100%. Next, 176 microliters Delvotec TS10/L (starter culture, DSM, The Netherlands) were added and the milk was gently stirred for 1 hour at 34° C. After this hour, optionally, the yeast extract was added, followed by another 10 minutes of stirring. Coagulation was initiated by addition of 80 microliters Fromase 750 XLG (DSM, The Netherlands). After 45 minutes the curd was cut during 60 seconds and left for another 15 minutes. Then the temperature was raised to 41° C. under gentle stirring until the pH had dropped to pH6.2. Whey was separated from the curd, and the curd was double-folded on itself. The wet curd was turned every 15 minutes until the pH reached 5.2-5.4. The curd was subsequently cut into straps and salt was added (to 3% w/v) and mixed with the curd. Hot water (78° C.) was than added and the curd was kneaded for 3 minutes after which it was cooled in ice. Finally, the kneaded curd was weighed.

### Example 3

### Effect of Yeast Extract on the Cheese Making Properties of Milk Containing High Heated Milk

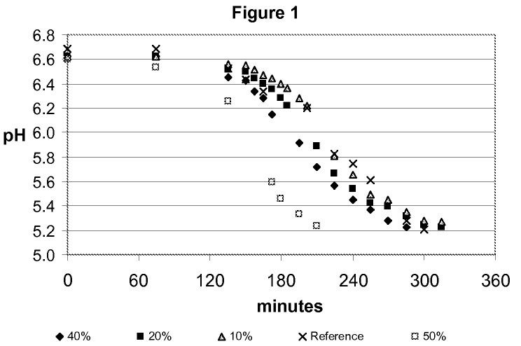

Mozzarella was prepared at 1 L scale, using the protocol described in example 2. Milk was used that contained 30% high heated milk (80° C., 10 minutes) and 0.1% (w/v) Gistex LS (DSM, The Netherlands) were added. In the control experiment, only pasteurized milk was used and no yeast extract was added. Surprisingly, the milk containing the Gistex LS acidified very fast, leading to curd with poor knitting characteristics. The curd particles were much less cohesive compared to the regular situation, leading to fine curd particles which are not retained and therefore lead to yield losses. In order to circumvent this problem, the dosage of starter culture was reduced in steps to 50, 40, 20 and 10% of the original doses as given in Example 2. The acidification curves are given in FIG. 1, including a reference acidification curve under conditions as given in example 2 without Gistex LS. Clearly, the reduction in amount of culture added leads to a reduction in rate of acidification. A reduction to 20% of the regular doses of starter culture in the presence of 0.1% Gistex LS leads to an acidification rate that is very similar to the curve recorded in absence of Gistex LS. The fast acidification rate is surprising, since it was not observed when protein hydrolysates were added to cheese milk as described in EP 24557. The use of Gistex LS surprisingly leads to a reduction in required starter culture leading to cost savings, which is a significant economic interest.

Mozzarella cheeses were subsequently prepared as described in Example 2, but in case Gistex LS was added the dosage of starter culture was reduced to 20% of the dosis indicated in Example 2. The weights of the cheese produced are given in the table below:

| | % Gistex LS | Wet curd | |
|---|---|---|---|
| Sample | (AHGWA 02) | (grams) | Mozzarela (g) |
| Control (non-heated milk) | — | 112 | Not determined |
| Non-heated milk containing | — | 126 | 121 |
| 30% high heated milk | | | |
| Non-heated milk containing | 0.1% | 137 | 126 |
| 30% high heated milk | | | |

In this example, 30% of high heated milk was included in the non-heated cheese milk. This milk shows impaired clotting characteristics and slightly less cohesive curd, but still results in an increased amount of wet curd compared to the control in which only non-heated milk was used (126 vs 112 grams respectively). Addition of the Gistex LS results in a significant increase in wet curd, compared to absence of Gistex LS (137 vs 126 grams) and also results in a significant increase in Mozzarella cheese (126 vs 121 grams). Based on Mozzarella, a yield increase of 4% is achieved. These results are reproducible over a series of experiments, although the magnitude of the yield improvement varied slightly with milk composition.

### Example 4

### Fortification of Yeast Extract with Malic Acid or Ammonium Acetate

Gistex LS was dissolved in MilliQ water (10 mg/ml) containing 50 mM ammonium acetate after which the pH was adjusted to pH5 using acetic acid. The solution was frozen and freeze dried and redissolved at 10 mg/ml before use, and was coded GistexLSAcMilk samples were prepared using reconstituted milk as described in example 1. The milk was heated at 80° C. for 3 minutes. Solutions were prepared in 1.5 ml Eppendorff tubes from this heated milk by adding to 450 microliters of the milk 50 microliters of solutions as indicated in the table below:

| Sample code | Additive | 20 minutes | 40 minutes | 60 minutes |
|---|---|---|---|---|
| A | GistexLS (10 mg/ml) | 0 | 1 | 2 |
| B | GistexLS (10 mg/ml) | 2 | 3 | 4 |
| | containing malic acid (0.7 mg/ml) | | | |
| C | Gistex LSAc (10 mg/ml) | 2 | 4 | 4, 5 |
| D | GistexLS (10 mg/ml) | 1 | 3 | 4 |
| | containing succinic acid (0.7 ml/ml) | | | |
| E | GistexLS (10 mg/ml) | 0 | 2 | 3 |
| | containing 0.7 mg/ml citric | | | |
| | acid | | | |

After addition of the indicated solutions to the heated milk, CaCl₂ was added (0.33 mM) Coagulation was initiated by addition of Maxiren 600 (to 0.08 IMCU/ml) and the sample was incubated at 35° C. For each sample, 3 tubes were incubated. A vial of each series was taken at 20, 40 and 60 minutes, vortexed and centrifuged in an Eppendorff centrifuge (1 min, 10,000 rpm). In case the milk has not coagulated, thereis no pellet and the sample will receive score 0.; when coagulation has started a pellet wil start to develop and the sample will receive a score of 1. With coagulation proceeding, the supernatant gets turbid (score 2) until it is completely clear (score 3). After that, the curd gets more difficult to spin down and start sticking to the wall of the tubes (receiving score 4 and finally 5 for fully clotted milk). Results vary slightly between experiments, resulting in scores like 4-5, meaning that in some experiments a score of 4 and in some a score of 5 was obtained. The results for samples A-E are given in the table above. Clearly, the clotting proceeds faster when the Gistex LS (sample A) has been fortified with either malic acid (Sample B) or ammonium acetate (sample C). B and C already receive scores of 2 at 20 minutes where A only receives this score after 60 minutes. Succinic acid (D) and citric acid (E) show fortification, but the effects are less pronounced compared to those obtained with malic acid and acetic acid. The addition of the carboxylic acids apparently enhances the effect of yeast extracts on milk clotting, resulting in a fortified yeast extract.

1. A method of producing curd or cheese from a milk composition comprising the following steps:
heat-treating the milk composition;
adding yeast extract to the heat-treated milk composition before or after the heat treatment;
coagulating the heat treated milk to form a gel;
processing the formed gel into a curd and separating the whey from the curd; and
optionally making cheese from the curd.

2. A method according to claim 1 whereby the yeast extract is added after the heat treatment.

3. A method according to claim 1 whereby the heat treatment causes whey denaturation of at least 30%.

4. A method according to claim 1 wherein the coagulation is an enzymatic coagulation.

5. A method according to claim 1 in which the yeast extract is fortified by addition of a carboxylic acid at levels of 1-10% (w/w) dry weight, preferably 5-10% (w/w), more preferably 7-9% (w/w).

6. A method of producing curd according to claim 10 in which the carboxylic acid is malonic acid or acetate.

7. A curd which comprise yeast extract and which is obtainable from the method according to claim 1.

8. A cheese which comprises yeast extract and which is produced from the curd of claim.

9. A dairy product which comprises curd of claim 7.

10. Use of a yeast extract to reduce the clotting time in a cheese making process whereby heat-treated milk is used.

11. Use of a yeast extract to increase the curd strength of a curd in a cheese making process whereby heat-treated milk is used.

12. Use of a yeast extract in producing a cheese prepared from heat-treated milk.

13. Use of a yeast extract in producing a dairy product prepared from heat-treated milk.

14. Use of a yeast extract to reduce the amount of starter culture in cheese making.

15. Use of claim 10 wherein the yeast extract is fortified, preferably is fortified with carboxylic acid.
